(19) United States
(12) Patent Application Publication
(10) Pub. No.: US 2022/0302446 A1
(43) Pub. Date: Sep. 22, 2022

(54) ZINC ION BATTERY POSITIVE ELECTRODE MATERIAL, PREPARATION METHOD THEREFOR, AND APPLICATION THEREOF

(71) Applicant: REHAB (QINGDAO) ENERGY TECHNOLOGY CO., LTD., Qingdao (CN)

(72) Inventors: Yunfeng LUO, Qingdao (CN); Yang FU, Qingdao (CN); Xiaosong LUO, Qingdao (CN); Pu CHEN, Waterloo (CA)

(21) Appl. No.: 17/832,691

(22) Filed: Jun. 6, 2022

Related U.S. Application Data
(63) Continuation of application No. PCT/CN2020/133159, filed on Dec. 1, 2020.

(30) Foreign Application Priority Data
Dec. 6, 2019 (CN) 201911241432.0

(51) Int. Cl. H01M 4/50; C01G 45/00; C01G 45/02; H01M 4/58; H01M 10/36

(52) U.S. Cl. CPC H01M 4/50; C01G 45/006; C01G 45/02; H01M 4/5825; H01M 10/36; C01P 2006/40; C01P 2002/72; H01M 2004/028

(57) ABSTRACT

Provided are a zinc ion battery positive electrode material, a preparation method therefor, and an application thereof. The preparation method for the zinc ion battery positive electrode material includes: performing a sintering treatment on manganese carbonate to obtain the zinc ion battery positive electrode material. In this method, through a heat treatment of manganese carbonate, a zinc ion battery positive electrode material with high performance can be obtained. In addition, the method requires low raw material and simple preparation processes, and thus it is suitable for industrial production.

### CROSS-REFERENCE TO RELATED APPLICATIONS

The present application is a continuation of International Patent Application No. PCT/CN2020/133159, filed on Dec. 1, 2020, which claims priority to Chinese Patent Application No. 201911241432.0, entitled “ZINC ION BATTERY POSITIVE ELECTRODE MATERIAL, PREPARATION METHOD THEREFOR, AND APPLICATION THEREOF”, filed with China National Intellectual Property Administration on Dec. 6, 2019. The entire disclosures of the aforementioned applications are incorporated herein by reference.

### FIELD

The present disclosure relates to the field of zinc ion batteries, and more particularly, to a zinc ion battery positive electrode material, a preparation method therefor, and an application thereof.

### BACKGROUND

Zinc ion battery, as a new type of secondary aqueous battery developed and advanced in recent years, has advantages such as high energy density, high power density, high efficiency and safety in discharge process, non-toxic and cheap battery materials, simple preparation process, etc. Thus, the zinc ion battery has good application and development prospect in large-scale energy storage and other fields.

For the reported positive electrode materials for aqueous zinc ion batteries, most of them use lithium manganate and manganese dioxide as positive electrode materials of aqueous zinc ion batteries. Manganese dioxide, as positive electrode material in aqueous zinc ion batteries, is generally synthesized with a hydrothermal method, a coprecipitation method, or a liquid phase method adopting potassium permanganate as oxidant. However, the existing lithium manganate positive electrode materials have low specific capacity and high raw material cost. The synthesis methods such as the hydrothermal method, the coprecipitation method, and the liquid phase method adopting potassium permanganate as oxidant require complicated preparation processes, but has low yield and high cost in raw material, and thus, they are not conducive to a large-scale production.

Therefore, the existing zinc ion battery positive electrode material and the preparation method therefor still need to be further studied.

### SUMMARY

The present disclosure aims to solve one of the technical problems in the related art at least to a certain extent. To this end, the present disclosure provides a zinc ion battery positive electrode material, and a preparation method for the zinc ion battery positive electrode material, and an application of the zinc ion battery positive electrode material. The preparation method for the zinc ion battery positive electrode material can obtain a zinc ion battery positive electrode material with high performance by performing a heat treatment on manganese carbonate. In addition, the raw material cost is low, the preparation process is simple, and the method is suitable for industrial production. The method includes: performing a sintering treatment on manganese carbonate to obtain the zinc ion battery positive electrode material. In this method, manganese carbonate is sintered at different temperatures, and the sintered product can be used as a positive electrode material of an aqueous zinc ion battery. Compared with the existing methods for preparing manganese dioxide positive electrode materials, such as a hydrothermal method, a potassium permanganate oxidation method, the method provided by the present disclosure requires lower raw material cost and simpler preparation processes, and the obtained product has better electrochemical performance and higher specific capacity.

In addition, the preparation method for the zinc ion battery positive electrode material according to the above embodiment of the present disclosure may also have the following additional technical features.

In some embodiments of the present disclosure, the sintering treatment is performed at a temperature ranging from 150° C. to 500° C.

In some embodiments of the present disclosure, a duration of the sintering treatment ranges from 0.5 hour to 20 hours.

In some embodiments of the present disclosure, a duration of the sintering treatment ranges from 2 hours to 8 hours.

In another aspect of the present disclosure, the present disclosure proposes a zinc ion battery positive electrode material. According to the embodiment of the present disclosure, the zinc ion battery positive electrode material is prepared by the preparation method for the zinc ion battery positive electrode material according to the above embodiment. Therefore, the zinc ion battery positive electrode material has better electrochemical performance, higher specific capacity, low raw material cost, and simple preparation process compared with the existing manganese dioxide positive electrode material prepared by the hydrothermal method or the potassium permanganate oxidation method.

In addition, the preparation method for the zinc ion battery positive electrode material according to the above embodiments of the present disclosure may also have the following additional technical features.

In some embodiments of the present disclosure, the zinc ion battery positive electrode material includes at least one of sintered manganese carbonate, sintered manganese dioxide, or sintered manganese (III) oxide.

In some embodiments of the present disclosure, the zinc ion battery positive electrode material is sintered manganese carbonate, sintered manganese dioxide, or sintered manganese (III) oxide.

In yet another aspect of the present disclosure, the present disclosure proposes a zinc ion battery. According to the embodiment of the present disclosure, the zinc ion battery includes the zinc ion battery positive electrode material of the above embodiment. Therefore, the zinc ion battery has all the features and advantages described above with respect to the positive electrode material of the zinc ion battery, which will not be described in detail herein. Generally speaking, the zinc ion battery has excellent capacity and cycle performance.

Additional aspects and advantages of the present disclosure will be provided at least in part in the following description, or will become apparent at least in part from the following description, or can be learned from practicing of the present disclosure.

### BRIEF DESCRIPTION OF DRAWINGS

The above and/or additional aspects and advantages of the present disclosure will become more apparent and more understandable from the following description of embodiments in conjunction with the accompanying drawings, in which:

FIG. 1 illustrates XRD test results of zinc ion battery positive electrode materials prepared in Example 1 to Example 4;

FIG. 2 illustrates cyclic performance test results, at a current density of 10 mA/g, of zinc ion batteries made of the zinc ion battery positive electrode materials prepared in Example 1 to Example 4; and

FIG. 3 illustrates cyclic performance test results, at a current density of 50 mA/g, of zinc ion batteries made of the zinc ion battery positive electrode materials prepared in Example 1 to Example 4.

### DESCRIPTION OF EMBODIMENTS

Embodiments of the present disclosure are described in detail below. The embodiments described below are illustrative and merely intended to explain, rather than limiting, the present disclosure. The specific techniques or conditions that are not indicated in the embodiments shall be those described in the literatures in the related art or shall follow the product specification. The used reagents or instruments without indicating the manufactures shall be the conventional and commercially available products.

Preparation method for positive electrode material of zinc ion battery

In an aspect of the present disclosure, the present disclosure provides a preparation method for a zinc ion battery positive electrode material. According to the embodiments of the present disclosure, the method includes: performing a sintering treatment on manganese carbonate to obtain the zinc ion battery positive electrode material. According to the method, the sintering treatment is performed on the manganese carbonate at different temperatures, and the sintered product can be used as a positive electrode material for an aqueous zinc ion battery. Compared with the existing methods for preparing manganese dioxide positive electrode materials such as the hydrothermal method and the potassium permanganate oxidation method, the method provided by the present disclosure has advantages such as lower raw material cost, simpler preparation processes, better electrochemical performance, and higher specific capacity.

Applicant has found through research that, with an increase in a temperature of the sintering treatment, a material structure of manganese carbonate will undergo a phase transformation, and the phase transformation of the material structure can be controlled by controlling the temperature of the sintering treatment and a duration of the sintering treatment, thereby obtaining a new positive electrode material with excellent electrochemical performance.

According to some embodiments of the present disclosure, the above sintering treatment is performed at a temperature ranging from 150° C. to 500° C. Specifically, the temperature of the sintering treatment may be 150° C., 180° C., 200° C., 230° C., 250° C., 290° C., 320° C., 340° C., 370° C., 420° C., 460° C., 500° C., etc. By conducting the sintering treatment on manganese carbonate at the above temperature conditions, the property of the prepared positive electrode material can be significantly improved.

According to some embodiments of the present disclosure, the sintering treatment is performed at a temperature ranging from 150° C. to 320° C. Specifically, the temperature of the sintering treatment may be 150° C., 180° C., 200° C., 230° C., 250° C., 290° C., 320° C., etc. In this way, the sintered MnCO₃ product is still in MnCO₃ phase, but the sintered product, through the sintering heat treatment, has significantly improved properties over the MnCO3 materials without undergoing the heat treatment.

According to some embodiments of the present disclosure, the sintering treatment is performed at a temperature ranging from 320° C. to 360° C. Specifically, the temperature of the sintering treatment may be 320° C., 330° C., 340° C., 350° C., 360° C., etc. Therefore, the sintered MnCO₃ product is mainly in MnO₂ phase. Applicant has found through research that, as the positive electrode material, MnO₂ obtaining by performing the sintering treatment on MnCO₃ has better specific capacity than MnO₂ prepared by the hydrothermal method and the commercially available electrolytic MnO₂.

According to some embodiments of the present disclosure, the sintering treatment is performed at a temperature ranging from 360° C. to 500° C. Specifically, the temperature of the sintering treatment may be 360° C., 400° C., 420° C., 450° C., 470° C., 500° C., etc. In this way, the sintered MnCO₃ product is Mn₂O₃.

According to some embodiments of the present disclosure, a duration of the sintering treatment may range from 0.5 hour to 20 hours. For example, the duration of the sintering treatment may be 0.5 hour, 1 hour, 2 hours, 5 hours, 8 hours, 10 hours, 15 hours, 20 hours, etc. In this way, the performance of the prepared positive electrode material product can be further improved.

According to some embodiments of the present disclosure, the duration of the sintering treatment may range from 2 hours to 8 hours, e.g., 2 hours, 3 hours, 4 hours, 5 hours, 6 hours, 7 hours, 8 hours, etc. In this way, the performance of the prepared positive electrode material product can be further improved.

According to some embodiments of the present disclosure, the above-described preparation method for the zinc ion positive electrode material may further include, subsequent to the sintering treatment: grinding the sintered product. In this way, the sintered product can be ground to a target granularity. The specific target granularity is not particularly limited and can be selected by those skilled in the art as desired.

Zinc ion battery positive electrode material

In another aspect of the present disclosure, the present disclosure proposes a zinc ion battery positive electrode material. According to the embodiment of the present disclosure, the zinc ion battery positive electrode material is prepared by the preparation method for the zinc ion battery positive electrode material according to the above embodiments. Therefore, the zinc ion battery positive electrode material has better electrochemical performance, higher specific capacity, low raw material cost, and simple preparation processes, compared with the existing manganese dioxide positive electrode material prepared by the hydrothermal method or the potassium permanganate oxidation method.

According to some embodiments of the present disclosure, the zinc ion battery positive electrode material includes at least one of sintered manganese carbonate, sintered manganese dioxide, or sintered manganese (III) oxide. Specifically, the sintered manganese carbonate can be prepared and obtained by performing the sintering treatment on the commercial manganese carbonate at a temperature ranging from 150° C. to 350° C. The sintered manganese dioxide can be prepared and obtained by performing the sintering treatment on commercial manganese carbonate at a temperature ranging from 320° C. to 360° C. The sintered manganese (III) oxide can be prepared and obtained by performing the sintering treatment on commercial manganese carbonate at a temperature ranging from 360° C. to 500° C.

According to some embodiments of the present disclosure, the zinc ion battery positive electrode material is sintered manganese carbonate, sintered manganese dioxide, or sintered manganese (III) oxide.

Zinc ion battery

In yet another aspect of the present disclosure, the present disclosure proposes a zinc ion battery. According to the embodiments of the present disclosure, the zinc ion battery includes the zinc ion battery positive electrode material according to the above embodiments. Therefore, the zinc ion battery has all the features and advantages described above with respect to the positive electrode material of the zinc ion battery, which will not be individually described herein. Generally speaking, the zinc ion battery has excellent capacity and cycle performance.

According to an embodiment of the present disclosure, the zinc ion battery includes a positive electrode plate, a separator, a negative electrode plate, and electrolyte. Specifically, the positive electrode plate includes the zinc ion battery positive electrode material according to the above embodiments, and auxiliary materials such as conductive agent and binder, which are common in the related art. The negative electrode plate can be a zinc foil, or a zinc powder negative electrode made by slurred copper mesh current collector. The separator is not particularly limited to a specific type, and the electrolyte can be zinc sulfate-based aqueous solution.

The present disclosure is described below with reference to specific examples. These examples are merely illustrative, rather than limiting the present disclosure in any way.

### EXAMPLE 1

(1) Manganese carbonate, as raw material, was placed in a box furnace for heat treatment. A temperature of the sintering treatment was 320° C., and a duration of the sintering treatment was 4 hours.

(2) After cooling to the room temperature, the material was taken out and ground with agate mortar to obtain a positive electrode material, which was determined to be MnCO₃ through an XRD detection.

(3) Preparation of the battery positive electrode plate: homogenizing a slurry with a ratio of the positive electrode material: acetylene black: PVDF=7: 2: 1; evenly coating the uniform positive electrode slurry on a conductive PE film; and placing it in an oven for vacuum drying at 60° C. for 10 hours.

(4) Battery assembly: positive electrode was the positive electrode material prepared by the above steps; negative electrode was a zinc foil; separator was an absorbent glass fiber felt separator (AGM separator); electrolyte was an aqueous zinc sulfate solution at a concentration of 1.8 mol/L.

The AGM separator, after being fully immersed in the liquid electrolyte, was assembled with the above-mentioned positive electrode material and negative electrode Zn foil to obtain a battery

(5) Battery testing:

The specific capacity of zinc ion battery was 277 mA.h/g at a current density of 10 mA/g at 25° C.

The specific capacity of zinc ion battery was 173 mA.h/g at a current density of 50 mA/g at 25° C.

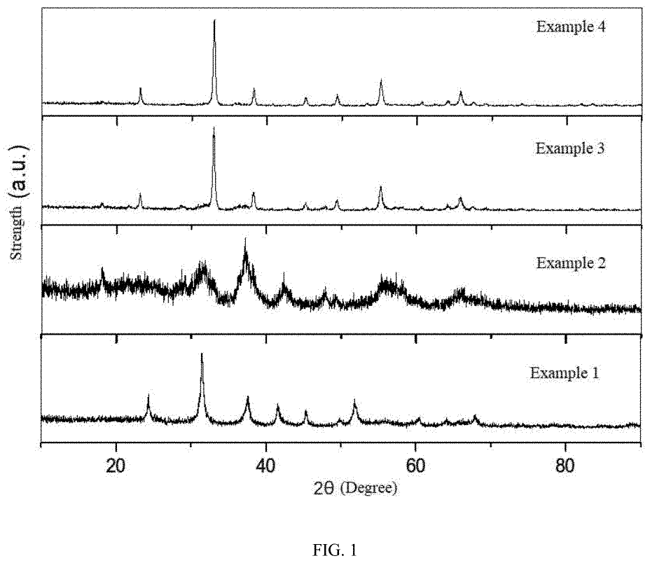

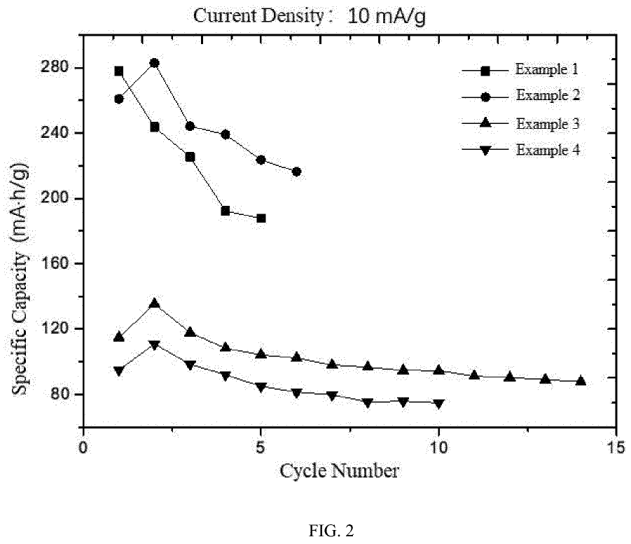

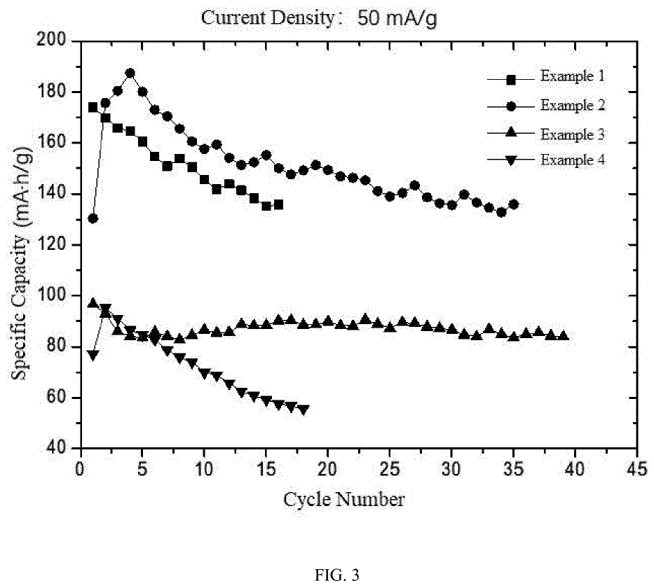

The XRD test result of the positive electrode material is shown in FIG. 1, and the cycle performance of battery is shown in FIG. 2 and FIG. 3.

### EXAMPLE 2

The positive electrode material and the battery for testing were prepared in the substantially same manner as described in Example 1, except that the temperature of the sintering treatment was 340° C., and the positive electrode material was determined to be MnO₂ through the XRD detection.

Battery testing:

The specific capacity of zinc ion battery was 282 mA.h/g at a current density of 10 mA/g at 25° C.

The specific capacity of zinc ion battery was 187 mA.h/g at a current density of 50 mA/g at 25° C.

The XRD test result of the positive electrode material is shown in FIG. 1, and the cycle performance of batteries is shown in FIG. 2 and FIG. 3.

### EXAMPLE 3

The positive electrode material and the battery for testing were prepared in the substantially same manner as described in Example 1, except that the temperature of the sintering treatment was 370° C., and the positive electrode material was determined to be Mn₂O₃ through the XRD detection.

Battery testing:

The specific capacity of zinc ion battery was 135 mA.h/g at a current density of 10 mA/g at 25° C.

The specific capacity of zinc ion battery was 96 mA.h/g at a current density of 50 mA/g at 25° C.

The XRD test result of the positive electrode material is shown in FIG. 1, and the cycle performance of batteries is shown in FIG. 2 and FIG. 3.

### EXAMPLE 4

The positive electrode material and the battery for testing were prepared in the substantially same manner as described in Example 1, except that the temperature of the sintering treatment was 420° C., and the positive electrode material was determined to be Mn₂O₃ through the XRD detection.

Battery testing:

The specific capacity of zinc ion battery was 110 mA.h/g at a current density of 10 mA/g at 25° C.

The specific capacity of zinc ion battery was 95 mA.h/g at a current density of 50 mA/g at 25° C.

The XRD test result of the positive electrode material is shown in FIG. 1, and the cycle performance of batteries is shown in FIG. 2 and FIG. 3.

### Comparative Example 1

Using the commercially available MnCO₃ without undergoing a heat treatment as a positive electrode material, a zinc ion battery was prepared and tested in the same manner as described in Example 1.

The specific capacity of zinc ion battery was 85 mA.h/g at a current density of 10 mA/g at 25° C.

The specific capacity of zinc ion battery was 73 mA.h/g at a current density of 50 mA/g at 25° C.

The test results indicate that, compared with the heat-treated MnCO₃ material in Example 1, the zinc ion battery made of MnCO₃ without undergoing the heat treatment has a significantly lower specific capacity. The potential reasons may be in that a crystallinity of MnCO₃ may deteriorate due to the sintering treatment, and manganese ions can be easily released and intercalated, thereby obtaining a better specific capacity.

### Comparative Example 2

1.7384 g of potassium permanganate (0.011 mol) and 0.7437 g of manganese sulfate monohydrate (0.0044 mol) were weighed and dissolved in 80 ml of deionized water. The solution was stirred magnetically for 2 hours to form a uniform solution. The solution was then transferred to a stainless-steel hydrothermal reactor with a volume of 100 ml and kept at 160° C. for 12 hours. After a suction-filtered in vacuum, the product was washed with deionized water and dried in an oven at 60° C. for 8 hours, to obtain MnO₂ positive electrode material. The positive electrode material was used to assemble a zinc ion battery in the same way as described in Example 1 for testing.

The specific capacity of zinc ion battery was 156 mA.h/g at a current density of 10 mA/g at 25° C.

The specific capacity of zinc ion battery was 120 mA.h/g at a current density of 50 mA/g at 25° C.

The test results indicate that the zinc ion battery made of the MnO₂ material prepared through the sintering treatment in Comparative Example 2 has a significantly lower specific capacity than that made of the MnO2 material prepared by the sintering treatment in Example 2.

### Comparative Example 3

Using the commercially available electrolytic MnO₂ as a positive electrode material, a zinc ion battery was prepared and tested in the same manner as described in Example 1.

The specific capacity of zinc ion battery was 78 mA.h/g at a current density of 10 mA/g at 25° C.

The specific capacity of zinc ion battery was 62 mA.h/g at a current density of 50 mA/g at 25° C.

The test results indicate that the zinc ion battery made of the commercially available electrolytic MnO₂ material in Comparative Example 3 a significantly lower specific capacity than that made of the MnO₂ material prepared by the sintering treatment in Example 2.

In the specification, description with reference to the terms “an embodiment”, “some embodiments”, “an example”, “a specific example”, “some examples”, etc., means that specific features, structure, materials, or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner. In addition, different embodiments or examples and features of different embodiments or examples described in the specification may be combined by those skilled in the art without mutual contradiction.

The embodiments of present disclosure as illustrated and described above are merely exemplary and shall not be construed as limitations of the present disclosure. Those skilled in the art are able to make changes, modifications, alternatives, and variations to these embodiments without departing from the scope of the present disclosure.

What is claimed is:

1. A preparation method for a zinc ion battery positive electrode material, the preparation method comprising: performing a sintering treatment on manganese carbonate to obtain the zinc ion battery positive electrode material.

2. The preparation method according to claim 1, wherein the sintering treatment is performed at a temperature ranging from 150° C. to 500° C.

3. The preparation method according to claim 1, wherein a duration of the sintering treatment ranges from 0.5 hour to 20 hours.

4. The preparation method according to claim 1, wherein a duration of the sintering treatment ranges from 2 hours to 8 hours.

5. A zinc ion battery positive electrode material, prepared by the method according to claim 1.

6. A zinc ion battery positive electrode material, prepared by the method according to claim 2.

7. A zinc ion battery positive electrode material, prepared by the method according to claim 3.

8. A zinc ion battery positive electrode material, prepared by the method according to claim 4.

9. The zinc ion battery positive electrode material according to claim 5, comprising at least one of sintered manganese carbonate, sintered manganese dioxide, or sintered manganese (III) oxide.

10. The zinc ion battery positive electrode material according to claim 5, being sintered manganese carbonate, sintered manganese dioxide, or sintered manganese (III) oxide.

11. A zinc ion battery, comprising the zinc ion battery positive electrode material according to claim 5.
